(19) United States
(12) Patent Application Publication
(10) Pub. No.: US 2013/0179715 A1
(43) Pub. Date: Jul. 11, 2013

(54) SYSTEMS AND METHODS FOR REDUCING ENERGY CONSUMPTION IN SENSOR NETWORKS

(71) Applicant: TEXAS INSTRUMENTS INCORPORATED, Dallas, TX (US)

(72) Inventors: Yanjun SUN, San Diego, CA (US); Soon-Hyeok CHOI, Allen, TX (US); Sejoong LEE, San Diego, CA (US); Ariton E. XHAFA, Plano, TX (US)

(73) Assignee: TEXAS INSTRUMENTS INCORPORATED, Dallas, TX (US)

(21) Appl. No.: 13/738,124

(22) Filed: Jan. 10, 2013

Related U.S. Application Data
(60) Provisional application No. 61/584,970, filed on Jan. 10, 2012.

(51) Int. Cl. G06F 1/32

(52) U.S. Cl. CPC G06F 1/3234
USPC 713/323

(57) ABSTRACT

A system includes a volatile memory and state information management logic. The volatile memory includes a plurality of volatile storage locations. The state information management logic includes memory write tracking circuitry coupled to the volatile memory. The memory write tracking circuitry is configured to identify locations of the memory written subsequent to restoration of state information to the volatile memory on exit of a low-power mode of operation, and to store indicia of the identified locations.

### CROSS-REFERENCE TO RELATED APPLICATION

The present application claims priority to U.S. Provisional Patent Application No. 61/584,970, filed on Jan. 10, 2012 (Attorney Docket No. TI-71894PS) which is hereby incorporated herein by reference in its entirety.

### BACKGROUND

Wireless Sensor Networks (WSNs) are used in various application areas, including industrial process monitoring and control, environment and habitat monitoring, traffic control, building automation, healthcare applications, etc. In some such applications a powered sensor may be used in a harsh environment, and it is desirable for the sensor to be untethered after deployment for as long as possible. However, most sensors are powered by batteries, and limited battery capacity is a major limitation for deployment of untethered sensor nodes. Finite sensor node lifetime implies finite lifetime of the applications or additional cost and complexity to replace batteries. Energy harvesting is one alternative for increasing the longevity of sensor nodes. If an energy source is periodically available for harvesting, a sensor node may operate for a substantially longer time than if only battery-powered. However, WSNs require very small energy harvesting devices to keep the size of the sensor node and the cost of sensor node deployment to a minimum. Consequently, the amount energy harvested may be relative small.

### SUMMARY

Systems and methods for reducing energy consumption in a wireless sensor network are disclosed herein. In one embodiment, a system includes a volatile memory and state information management logic. The volatile memory includes a plurality of volatile storage locations. The state information management logic includes memory write tracking circuitry coupled to the volatile memory. The memory write tracking circuitry is configured to identify locations of the memory written subsequent to restoration of state information to the volatile memory on exit of a low-power mode of operation, and to store indicia of the identified locations.

In another embodiment, a method includes monitoring, by a wireless device, accesses to volatile memory. Locations of the volatile memory written by the wireless device subsequent to restoration of state information to the memory on exit of low-power mode of operation are identified by the wireless device. Indicia of the identified locations are stored.

In a further embodiment, a system includes a volatile memory, a non-volatile memory, a processor, and a software system. The volatile memory includes a plurality of volatile storage locations. The non-volatile memory includes a plurality of non-volatile storage locations. The software system causes the processor to store, in the non-volatile memory while operating in a non-low-power mode and prior to initiation of a transition to a low-power mode, state information needed to resume operation in the non-low-power mode from the low-power mode

### BRIEF DESCRIPTION OF THE DRAWINGS

For a detailed description of exemplary embodiments of the invention, reference will now be made to the accompanying drawings in which:

FIG. 1 shows a block diagram of an illustrative wireless sensor network in accordance with various embodiments;

FIG. 2 shows a block diagram of a sensor device configured to access a wireless sensor network in accordance with various embodiments;

FIGS. 3A-3B show block diagrams of state information management in accordance with various embodiments;

FIGS. 4A-4B show block diagrams of tracking circuitry in accordance with various embodiments;

FIGS. 5A-5B show block diagrams of a portion of a wireless sensor device including tracking circuitry in accordance with various embodiments; and

FIG. 6 shows a flow diagram for a method for managing state information in a wireless sensor device in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In a wireless sensor network (WSN), whether a sensor node is powered by battery or energy-harvesting, the lifetime and/or usefulness of the node is limited by energy available to power the node. Consequently, energy waste in the sensor node reduces the operational time of the node, and with battery or energy harvesting it is important to reduce energy consumption to increase the operational life of the sensor node.

A sensor node can reduce energy consumption by entering a low-power mode when not actively sensing or communicating with other nodes or devices of the WSN. A low-power mode may be referred to as a sleep mode, doze mode, snooze mode, hibernate mode, etc. When employing a low-power mode, energy is dissipated (leakage power) to maintain state information in registers or memory. The state information is information produced by the node while operating in the non-low-power mode that must be backed-up and restored to resume the operations of the sensor node when exiting the low-power mode. The backup and resume operations consume energy. In low-power, low duty-cycle WSN sensor nodes, the energy dissipated to store, restore, and maintain the state information of a sensor node can determine the lifetime of the node.

Embodiments of the present disclosure extend the operating time of a sensor node by employing various techniques to reduce state maintenance energy dissipation. Some embodiments reduce the energy needed to store and restore node state information by reducing the amount of state information generated by the node that must be moved to state storage. Some embodiments include circuitry that tracks memory writes to identify areas of memory modified during node operations. Such embodiments may backup only the identified areas memory, thereby reducing the amount of information moved to/from state storage and in-turn reducing the energy associated with moving state information.

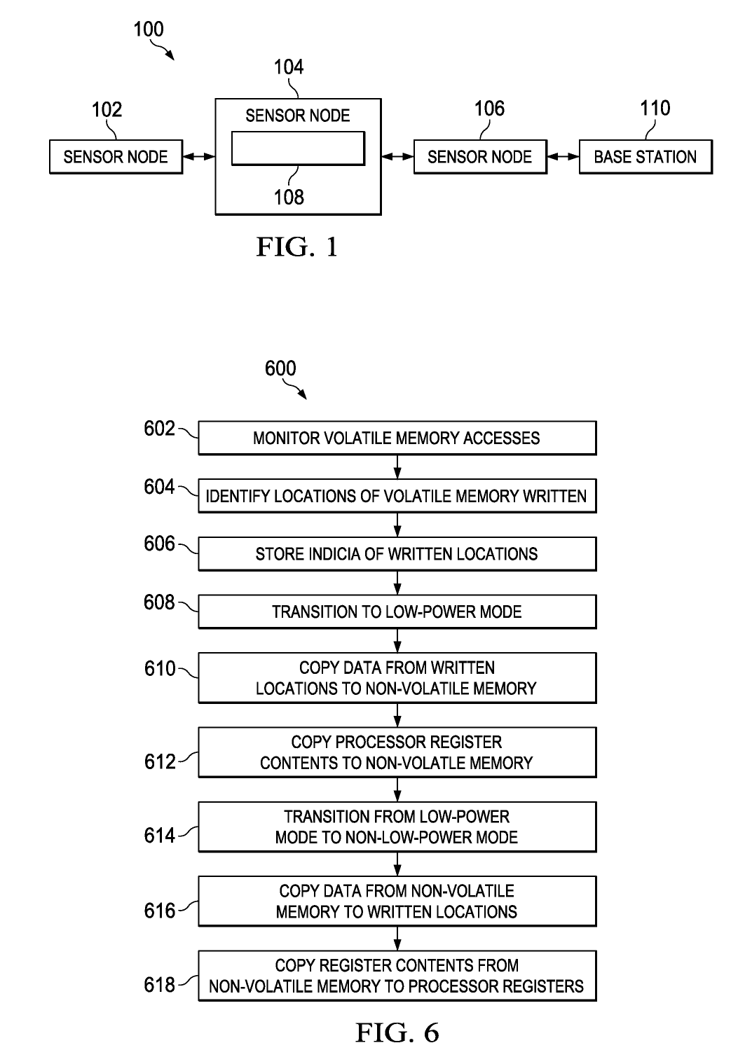

FIG. 1 shows a block diagram of an illustrative wireless sensor network 100 in accordance with various embodiments. The wireless sensor network 100 includes a plurality of wireless sensor devices (102, 104, 106), also referred to as wireless sensor nodes, and a base station 110. The wireless sensor nodes 102-106 detect a condition of the environment in which they are disposed, and wirelessly communicate information indicative of the sensed environment to the base station 110. Each wireless sensor node may communicate with neighboring wireless sensor nodes to form an ad-hoc network in which a wireless sensor node repeats transmissions received from other sensor nodes to relay data through the network 100. The base station 110 receives measurement values and other information transmitted by the sensor nodes 102-106, and may provide control information to the sensor nodes 102-106. While, as a matter of convenience, FIG. 1 shows only three sensor nodes and a single base station 110, in practice, the system 100 may include any number of wireless sensor nodes and base stations.

The sensor node 104 includes state management logic 108 that increases the operating life of the sensor node 104 by reducing the energy consumed to maintain state information that is stored and restored when the sensor node 104 transitions between low-power and non-low-power operational modes. Some embodiments of the state management logic 108 may include a software system that reduces the amount of state information to be backed-up and restored on transitions between low-power and non-low-power operational modes. Some embodiments include tracking circuitry that reduces the state information transferred between volatile and non-volatile memory by identifying portions of volatile memory modified while the sensor node 104 is operating in a non-low-power mode, and backing up only the identified portions of volatile memory to non-volatile memory when entering a low-power mode.

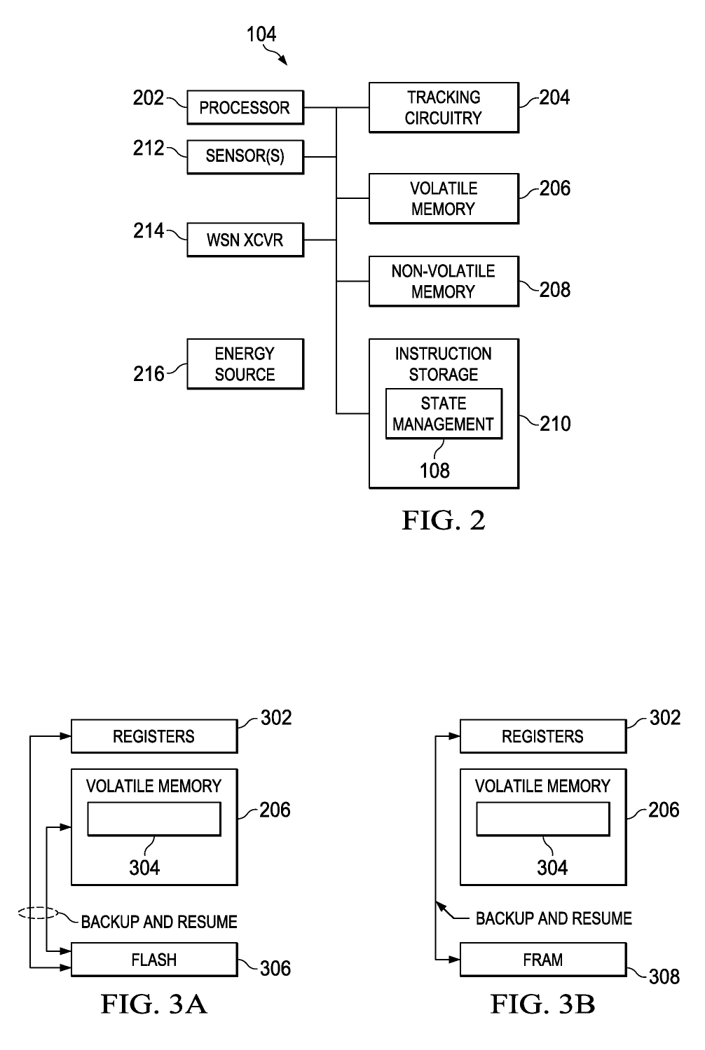

FIG. 2 shows a block diagram of a sensor device 104 configured to access a wireless sensor network 100 in accordance with various embodiments. The sensor device 104 includes a processor 202, volatile memory 206, non-volatile memory 208, instruction storage 210, one or more sensor(s) 212, a wireless transceiver 214, and an energy source 216. Some embodiments also include tracking circuitry 204. The processor 202 may be a general-purpose microprocessor or other instruction execution device suitable for use in a wireless sensor node. The volatile memory 206 retains data stored therein only while powered, and may be a semiconductor random access memory (RAM), such as static RAM (SRAM), or other volatile memory suitable for use in the wireless sensor node 104. The non-volatile memory 206 retains data stored therein after power has been removed, and may be a FLASH memory, electrically erasable programmable read-only memory (EEPROM), ferroelectric RAM (FRAM), or other non-volatile memory suitable for use in the wireless sensor node 104. The instruction storage 210 may comprise non-volatile and/or volatile memory for storing software instructions that are executed by the processor 202. At least a portion of the state management logic 108 may be stored as instructions in the instruction storage 210.

The sensor(s) 212 include one or more transducer that detects conditions about the wireless sensor node 104 and provides measurements of the conditions to the processor 202. For example, embodiments of the sensor(s) 212 may measure temperature, pressure, electrical current, humidity, or any other parameter associated with the environment of the wireless sensor node 104. The transceiver 214 converts signals between electrical and electromagnetic forms to allow the wireless sensor node 104 to communicate with the sensor nodes 102, 106, the base station 110, and other devices. The energy source 216 provides power to operate the processor 202, the memories 206, 208, and other components of the wireless sensor node 104. The energy source 216 may include a battery, an energy harvesting system, and/or other power source suitable for use in the wireless sensor node 104.

In a non-low-power, the wireless sensor node 104 may enable power to some or all of the components 202-214 to allow the node 104 to acquire and transmit measurement values. In a low-power mode, the wireless sensor node 104 may remove power from at least some components that are powered while in a non-low-power mode. The wireless sensor node 104 may maximize energy savings by removing power from as many of the components 202-210 as possible. For example, power may not be provided to the processor 202 (or parts thereof), the tracking circuitry 204, the memories 206, 208, the instruction storage 201, the sensor(s) 212, and/or the WSN transceiver 214 while in a low-power mode. In order to resume operation on exit of the low-power mode, the wireless sensor node 104 may store state information in non-volatile memory 208 that is employed to restore the processor 202, and other components, to a configuration reflecting operation just prior to entry into the low-power mode.

Some embodiments of the wireless sensor node 104 reduce system state information to be maintained in non-volatile memory via the programming stored in the instruction storage 210. For example, FIG. 3A shows registers 302 (e.g., internal registers of the processor 202), volatile memory 206, and FLASH memory 306, where the FLASH memory 306 may be part of the non-volatile memory 208. The volatile memory 206 may contain a DATA section and stack structure employed by the processor 202 while executing instructions stored in the instruction storage 210. To transition to a low-power mode (e.g., to fully power down the wireless sensor node 104), the node 104 can back up the contents of the registers 302 and the volatile memory 206 in the FLASH memory 306 prior to removing power from the processor 202 and the volatile memory 206. Some embodiments of the wireless sensor node 202 employ software systems that minimize stack operations and thus employ little or no stack 304. With such software systems, the processor 202 may back up little or no stack data to FLASH memory 306 prior to removing power from the volatile memory 206. Some embodiments employ the Contiki operating system to reduce stack size. In some embodiments of the wireless sensor device 104, the software programming executed by the processor 202 uses only static variables, thereby reducing the stack size to zero and requiring no back up or restoration of the stack when transitioning between low-power and non-low-power modes.

Some embodiments of the wireless sensor node 104 can further reduce the state information that is moved to/from non-volatile memory 208 in association with low-power mode entry/exit by storing data in FRAM rather than in volatile memory 206. If FRAM or other fast read/write non-volatile memory technology is used to store data during program execution in a non-low-power mode, then only the registers 302 need be backed up and restored in conjunction with low-power mode entry/exit. FIG. 3B shows registers 302 (e.g., internal registers of the processor 202), volatile memory 206, and FRAM 308, where the FRAM 308 may be part of the non-volatile memory 208. The processor 202 stores state information in the FRAM 308 while operating in non-low-power modes, and consequently only registers 302 are backed up and restored from FRAM 308 on low-power mode entry/exit. Some embodiments may reduce the time and power required to back up and restore register contents using an instruction that causes the processor 202 to minimize the time required to move the register contents to/from non-volatile memory 208. By reducing the amount of state information that is moved to/from non-volatile memory 208, and/or the time required by move the state information on low-power mode entry/exit, embodiments of the wireless sensor node 104 reduce overall energy consumption and increase operational life.

In some embodiments of the wireless sensor node 104, only a fraction of the contents of the volatile memory 206 is changed during operation of the node 104 after transitioning from a low-power mode to a non-low-power mode. Consequently, if the contents of the volatile memory 206 has been previously copied into the non-volatile memory 208, then some embodiments of the wireless sensor node 104 copy to the non-volatile memory 208 only those portions or locations of the volatile memory 206 that have changed since the last low-power mode exit.

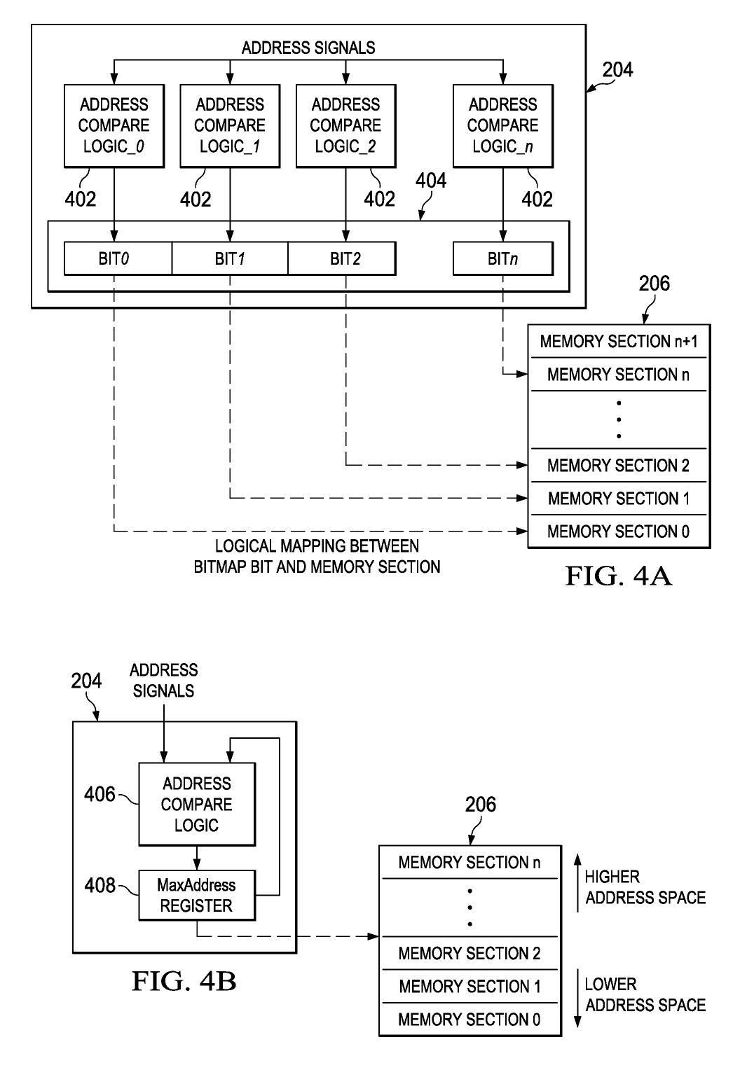

Some embodiments of the wireless sensor node 104 include the tracking circuitry 204 as part of the state management logic 108. The tracking circuitry 204 monitors access to the volatile memory 206 and determine what locations of the volatile memory 206 have been written and/or changed since the last low-power mode exit. FIG. 4A shows a block diagram of an embodiment of the tracking circuitry 204. In FIG. 4A the tracking circuitry 204 includes a plurality of address range comparators 402. Each of the address range comparators 402 monitors (snoops) address/control signals used to access the volatile memory 206 and identifies writes to the volatile memory 206 that occur within the address range associated with the comparator 402. The address range monitored by a comparator 402 may be defined by a set of upper address bits, and control signals monitored may include a write enable signal provided to the volatile memory 206. As shown in FIG. 4A, the sections of memory monitored by the comparators 402 may differ in size, and the size of a section may depend on memory space usage patterns of the sensor node 104.

The comparators 204 may be programmable so that the size of the memory section monitored by a comparator 204 is adjustable. The wireless sensor node 104 may apply an adaptive algorithm to determine the sizes of the memory sections such that an optimal memory division is determined that may minimize the size of memory footprint to be moved to the non-volatile memory 208 when the volatile memory 206 is backed-up.

The tracking logic 204 includes as set of flags 404, with a flag corresponding to each comparator 402. When a comparator 402 identifies a write to a section of the volatile memory 206, the flag corresponding to the comparator 402 is set to indicate that the section of memory 206 may have changed. When transitioning to a low-power mode, the processor 202 may copy to non-volatile memory 208 only those sections of the volatile memory 206 indicated to have changed by the flags 404. The flags 404 may be variables residing in the volatile memory 206 whose access is being tracked by the tracking logic 204.

As also shown in FIG. 4A, not all the memory sections (e.g., section n+1) are necessarily monitored by the tracking circuitry 204. If the memory usage pattern of a certain sensor application is predictable such that a section of the volatile memory 206 is always modified or never modified during operation, then the tracking circuitry 204 may be configured to not monitor the memory section.

FIG. 4B shows another embodiment of the tracking circuitry 204. The tracking circuitry 402 of FIG. 4B includes an address comparator 406 and a MaxAddress register 408. The address comparator 406 compares the addresses of the volatile memory 206 being written to an address value stored in the MaxAddress register 408. If the address being written is higher than the value stored in the MaxAddress register 408, then the address value being written is stored in the MaxAddress register 408. Thus, the tracking circuitry 204 of FIG. 4B determines the highest volatile memory address value written after entry to a non-low-power mode. On entry to low-power mode, the content of volatile memory 206 for each address up to that stored in the MaxAddress register 408 may be copied to the non-volatile memory 208.

The tracking circuitry 204 as shown in FIG. 4B may be advantageous if the usage pattern of the volatile memory 206 is linear such that the value stored in the MaxAddress register 408 represents the portion of the volatile memory 206 that has been modified. In this architecture, the memory section size depends on the bit-length of the MaxAddress register 408. If the MaxAddress register 408 is the same bit-length as the address bus, then a memory section is effectively the same as a word size. The MaxAddress register 408 may be a variable residing in the volatile memory 206 whose access is being tracked by the tracking logic 204.

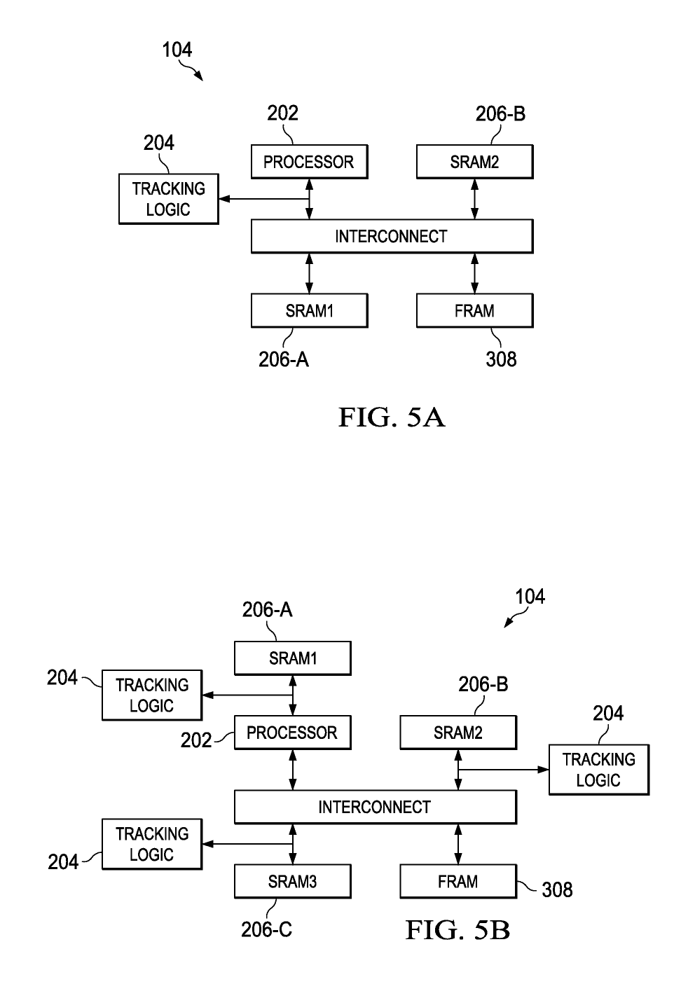

FIGS. 5A-5B show block diagrams of a portion of a wireless sensor device 104 including tracking circuitry 204 in accordance with various embodiments. In FIG. 5A, the volatile memory 206 includes two separates SRAMs 206-A, 206-B. A single instance of the tracking logic 204 is coupled to the processor 202. Thus, a single instance of the tracking logic 204 monitors access to both of the SRAMs 206-A, 206-B by monitoring memory access signals generated or viewable by the processor 202.

In FIG. 5B, the volatile memory 206 includes three separates SRAMs 206-A, 206-B, 206-C. A different instance of the tracking logic 204 is coupled to each of the SRAMs 206-A, 206-B, 206-C. Thus, each instance of the tracking logic 204 monitors access of a single one of the SRAMs 206-A, 206-B, 206-C. Such an arrangement may be employed if the interconnect is not a broadcasting shared media bus (i.e., memory access signals are not common to all the SRAMs).

Some embodiments of the processor 202 may include the tracking logic. In such embodiments, the tracking logic need not snoop the memory access signals, but rather may track access to volatile memory 206 and update access flags 404 or MaxAddress register 408 as part of memory write instruction execution by the processor 202. Some embodiments of the wireless sensor node 104 may include a direct memory access controller that moves state information between volatile memory 206 and non-volatile memory 208 based on the flags 404 of the value of the MaxAddress register 408.

Some embodiments of the wireless sensor node 104 also include a virtual memory system or LOAD to volatile memory on-access feature to further reduce energy consumed in backing up and restoring state information. With virtual memory management enabled, the sensor node 104 can relocate and pack often changed contents of the volatile memory 206 into a smaller number of memory blocks and thus require backup of a smaller portion of the volatile memory 206 prior to entry into a low-power mode. As most memory blocks may not be accessed while operating in a non-low-power mode, some embodiments of the wireless sensor node 104 may not restore all of the data (e.g., unused sections of the volatile memory 206) stored in non-volatile memory 208 to volatile memory 206 when exiting a low-power mode. In such embodiments, the memory management unit can load a section of volatile memory 206 from the non-volatile memory 208 if the section in volatile memory 206 is to be accessed. Thus, the amount of state information restored when exiting a low-power mode can also be reduced.

FIG. 6 shows a flow diagram for a method for managing state information in a wireless sensor device in accordance with various embodiments. Though depicted sequentially as a matter of convenience, at least some of the actions shown can be performed in a different order and/or performed in parallel. Additionally, some embodiments may perform only some of the actions shown. In some embodiments, at least some of the operations of the method 600, as well as other operations described herein, can be performed by the processor 202 executing instructions stored in a computer readable medium (e.g., instruction storage 210).

In block 602, the wireless sensor node 104 is operating in a non-low-power mode. The tracking circuitry 204 is monitoring accesses of the volatile memory 206. The tracking circuitry may monitor access of the volatile memory 206 by snooping the memory address and control signals generated to access the volatile memory 206. Some embodiments of the processor 202 may include circuitry that tracks volatile memory write operations as part of memory write instruction execution.

In block 604, the tracking circuitry 204 identifies locations (e.g., sections) of the volatile memory 204 that are being written. The tracking circuitry 204 may compare an address being written to a predetermined address range to identify a write to a particular section of the volatile memory. The tracking circuitry 204 may divide the volatile memory 206 into a plurality of sections and compare the write address to the address range corresponding to each section.

In block 606, if a write operation directed to a section of the volatile memory 206 is detected, then the tracking circuitry 204 stores indicia of the location written. For example, the tracking circuitry 204 may set a flag indicating which section of the volatile memory 206 is being written. The tracking circuitry 204 may maintain a flag value for each section of the volatile memory 206 being monitored.

In block 608, the wireless sensor device 104 is transitioning from non-low-power mode to low-power mode. Because some components of the sensor device 104 are powered off while in low-power mode, state information must be backed up prior to removal of power from the processor 202, the volatile memory 206, etc.

In block 610, data from locations in the volatile memory 206 identified by the tracking circuitry 204 as written while operating in the non-low-power mode are copied into the non-volatile memory 208. In some embodiments, the indicia of written locations generated by the tracking circuitry 204 may also be copied into the non-volatile memory 208. The copying may be performed by the processor 202 or by a DMA channel.

In some embodiments, the amount of state information copied to the non-volatile memory when entering the low-power mode is reduced by writing the state information to the non-volatile memory as part of the operation of the non-low-power mode and/or by employing a software system that uses little or no stack.

In block 612, contents of registers of the processor 202 are copied into the non-volatile memory 208, and portions of the wireless sensor device 104 are powered down to reduce energy consumption.

In block 614, the wireless sensor device 104 is transitioning from a low-power mode to a non-low-power mode. Power is restored to portions of the wireless sensor device 104 that were powered down while in the low-power mode.

In block 616, state information copied to the non-volatile memory 208 on entry to the low-power mode is read from the non-volatile memory 208 and restored to the volatile memory 206.

In block 618, the register contents copied to the non-volatile memory 208 on entry to the low-power mode is read from the non-volatile memory 208 and restored to the registers of the processor 202. Sensing and/or communication operations of the wireless sensing node 104 are executed.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a volatile memory comprising a plurality of volatile storage locations; and
state information management logic, comprising:
memory write tracking circuitry coupled to the volatile memory, the circuitry configured to:
identify locations of the memory written subsequent to restoration of state information to the volatile memory on exit of a low-power mode of operation; and
store indicia of the identified locations.

2. The system of claim 1, further comprising:
a non-volatile memory;
wherein, in conjunction with the system entering a low-power mode, the state information management logic is configured to:
copy data stored in the identified locations of the volatile memory to the non-volatile memory; and
optionally, store the indicia of the identified locations in the non-volatile memory.

3. The system of claim 1, wherein, in conjunction with exiting the low-power mode, the state information management logic is configured to move data previously copied to the non-volatile memory from the volatile memory to the identified locations based on the indicia of the identified locations previously stored in the non-volatile memory.

4. The system of claim 1, wherein the memory write tracking circuitry comprises:
a plurality of address range comparators each configured to identify a write to the memory in an address range corresponding to the address range comparator; and
a plurality of flags each corresponding to one of the address range comparators;
wherein each flag indicates whether a write to the address range corresponding to the flag has been detected subsequent to a last exit of the low-power mode.

5. The system of claim 4, wherein the address range corresponding to each comparator is programmable.

6. The system of claim 1, wherein the memory write tracking circuitry comprises an address comparator configured to identify a highest address of the volatile memory written subsequent to a last exit of the low-power mode.

7. The system of claim 1, further comprising a different instance of the memory write tracking circuitry coupled to each of a plurality of non-volatile memories.

8. The system of claim 1, further comprising a processor configured to write the state information to non-volatile memory and to write none of the state information to a stack in the non-volatile memory.

9. The system of claim 8, wherein the non-volatile memory is ferro-electric random access memory.

10. The system of claim 1, wherein the write tracking circuitry is part of memory write circuitry of a processor, and is activated to track addresses written by execution of a memory write by the processor.

11. The system of claim 1, wherein the write tracking circuitry is coupled to address and control conductors that provide address and control signals to the memory, and the write tracking circuitry identifies the locations written by snooping the address and control signals.

12. A method, comprising:
monitoring, by a wireless device, accesses to volatile memory;
identifying, by the wireless device, locations of the volatile memory written by the wireless device subsequent to restoration of state information to the memory on exit of low-power mode of operation; and
storing indicia of the identified locations.

13. The method of claim 12, further comprising:
transitioning, by the wireless device, from a non-low-power mode to a low-power mode; and
responsive to the transitioning:
copying data stored in the identified locations of the volatile memory to the non-volatile memory; and
optionally, storing the indicia of the identified locations in a non-volatile memory.

14. The method of claim 12, further comprising:
transitioning, by the wireless device, from a low-power mode to a non-low-power mode; and
responsive to the transitioning:
moving data previously copied to the non-volatile memory from the volatile memory to the identified locations based on the indicia of the identified locations previously stored in the non-volatile memory.

15. The method of claim 12, further comprising:
dividing an address range of the volatile memory into a plurality of sub address ranges;
wherein the identifying comprises identifying write operations to each of the sub address ranges; and
wherein the storing comprises maintaining a flag value corresponding to each of the sub address ranges that indicates whether a write operation has been detected in the sub address range.

16. The method of claim 12, wherein the identifying comprises identifying a highest address of the volatile memory written by the wireless device, and the indicia comprises a value of the highest address identified.

17. The method of claim 12, further comprising performing the identifying and storing separately for each of a plurality of non-volatile memories of the wireless device.

18. The method of claim 12, further comprising executing, by a processor of the wireless device, a software system that comprises no stack structure to copy to non-volatile memory from the volatile memory when entering a low-power mode.

19. The method of claim 12, further comprising storing, in non-volatile memory while operating in a non-low-power mode and prior to initiation of a transition to a low-power mode, state information needed to resume operation in the non-low-power mode from the low-power mode.

20. The method of claim 12, wherein the identifying comprises determining which of the locations are being written by at least one of:
snooping address and control signals provided to the volatile memory; and
extracting address information from memory write instructions executed by a processor of the wireless device.

21. A system, comprising:
a volatile memory comprising a plurality of volatile storage locations;
a non-volatile memory comprising a plurality of non-volatile storage locations;
a processor; and
a software system that causes the processor to store, in the non-volatile memory while operating in a non-low-power mode and prior to initiation of a transition to a low-power mode, state information needed to resume operation in the non-low-power mode from the low-power mode.

22. The system of claim 21, wherein the software system comprises no stack structure to copy to the non-volatile memory from the volatile memory when entering the low-power mode.

23. The system of claim 21, further comprising:
state information management logic, comprising:
memory write tracking circuitry coupled to the volatile memory, the circuitry configured to:
identify locations of the volatile memory written by the system subsequent to restoration of state information to the memory; and
store indicia of the identified locations.

24. The system of claim 23, wherein, in conjunction with entering a low-power mode, the state information management logic is configured to:
copy data stored in the identified locations of the volatile memory to the non-volatile memory; and
optionally, store the indicia of the identified locations in the non-volatile memory.

25. The system of claim 23, wherein, in conjunction with exiting a low-power mode, the state information management logic is configured to move data previously copied to the non-volatile memory from the volatile memory to locations in the volatile memory from which the data was copied to the non-volatile memory.

26. The system of claim 23, wherein the memory write tracking circuitry comprises:
a plurality of address range comparators each configured to identify a write to the memory in an address range corresponding to the address range comparator; and
a plurality of flags each corresponding to one of the address range comparators; wherein each flag indicates whether a write to the address range corresponding to the flag has been detected subsequent to a last exit of a low-power mode.

27. The system of claim 23, wherein the memory write tracking circuitry comprises an address comparator configured to identify a highest valued address of the memory written subsequent to a last exit of a low-power mode
